(19) United States
(12) Patent Application Publication
(10) Pub. No.: US 2024/0264127 A1
(43) Pub. Date: Aug. 8, 2024

(54) ACOUSTIC ACQUISITION MATRIX CAPTURE DATA COMPRESSION

(71) Applicant: EVIDENT CANADA, INC., Québec (CA)

(72) Inventors: Benoit Lepage, L'Ancienne-Lorette (CA); David Quinn, Lévis (CA); Alain Le Duff, Quebec (CA)

(21) Appl. No.: 18/571,621

(22) PCT Filed: Jun. 29, 2022
(86) PCT No.: PCT/CA2022/051040

§ 371 Date: Dec. 18, 2023

Related U.S. Application Data
(60) Provisional application No. 63/216,829, filed on Jun. 30, 2021.

(51) Int. Cl. G01N 29/46; G01N 29/07; G01N 29/42

(52) U.S. Cl. CPC G01N 29/46; G01N 29/07; G01N 29/42; G01N 2291/106; G06F 17/10; G06F 17/14; G06F 17/16

(57) ABSTRACT

Acoustic inspection productivity can be enhanced using techniques to perform compression of acquired acoustic data, such as data corresponding to elementary A-scan or other time-series representations of received acoustic echo data. In various approaches described herein, time-series data can be decimated for efficient storage or transmission. A representation of the time-series data can be reconstructed, such as by using a Fourier transform-based up-sampling technique or a convolutional interpolation filter, as illustrative examples. The techniques described herein can be used for a variety of different acoustic measurement techniques that involve acquisition of time-series data (e.g., A-Scan data). Such techniques include Full Matrix Capture (FMC) applications, plane wave imaging (PWI), or PAUT, as illustrative examples.

### CLAIM OF PRIORITY

This patent application claims the benefit of priority of Lepage et al., U.S. Provisional Patent Application Ser. No. 63/216,829, titled “ACOUSTIC ACQUISITION MATRIX CAPTURE DATA COMPRESSION,” filed on Jun. 30, 2021 (Attorney Docket No. 6409.210PRV), which is hereby incorporated by reference herein in its entirety.

### FIELD OF THE DISCLOSURE

This document pertains generally, but not by way of limitation, to non-destructive evaluation, and more particularly, to apparatus and techniques for providing acoustic inspection, such as using a full matrix capture (FMC) acquisition or other matrix acquisition approach where acquired A-scan data is compressed.

### BACKGROUND

Various inspection techniques can be used to image or otherwise analyze structures without damaging such structures. For example, x-ray inspection, eddy current inspection, or acoustic (e.g., ultrasonic) inspection can be used to obtain data for imaging of features on or within a test specimen. For example, acoustic imaging can be performed using an array of ultrasound transducer elements, such as to image a region of interest within a test specimen. Different imaging modes can be used to present received acoustic signals that have been scattered or reflected by structures on or within the test specimen.

### SUMMARY OF THE DISCLOSURE

Acoustic testing, such as ultrasound-based inspection, can include focusing or beam-forming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. In another approach, a Total Focusing Method (TFM) technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array. Such a TFM approach where A-scan data is obtained for each element in an array (or each defined aperture) can be referred to as a “full matrix capture” (FMC) technique.

Capturing time-series A-scan data either for PAUT or TFM applications can involve generating considerable volumes of data. For example, digitization of A-scan time-series data can be performed locally by a test instrument having an analog-front-end and analog-to-digital converter physically cabled to a transducer probe assembly. A corresponding digitized amplitude resolution (e.g., 8-bit or 12-bit resolution) and time resolution (e.g., corresponding to a sample rate in excess of tens or hundreds of megasamples per second) can result in gigabits of time-series data for each received A-scan record for later processing, particularly if such A-scan records are stored in a as full-bandwidth and full-resolution analytic representations.

Accordingly, the present inventors have recognized, among other things, that a technique can be used to reduce a size of a data set associated with storage or transmission of acoustic imaging data by selectively retaining information within a bandwidth of an acoustic probe signal chain and discarding data outside of such bandwidth. Accordingly, the present inventors have recognized that use of a reduced sample rate can be sufficient to convey such information, such as by down-sampling an originally-acquired time-series. Acoustic inspection productivity can be enhanced using techniques described herein to perform such selective reduction of acquired acoustic data volume, such as data corresponding to elementary A-scan or other time-series representations of received acoustic echo data. In the approach described herein, time-series data can be decimated for efficient storage or transmission. A representation of the time-series data can be reconstructed, such as by using a Fourier transform-based up-sampling technique or a convolutional interpolation filter, as illustrative examples. The techniques described herein can be used for a variety of different acoustic measurement techniques that involve acquisition of time-series data (e.g., A-Scan data). Such techniques include Full Matrix Capture (FMC) applications, plane wave imaging (PWI), or PAUT, as illustrative examples.

In an example, a machine-implemented method for processing compressed acoustic inspection data can include receiving down-sampled digital representations of acquired acoustic echo data corresponding to respective received acoustic echo signals, the respective received acoustic echo signals corresponding to transducer apertures of a multi-element electroacoustic transducer array used for an acoustic inspection operation, up-sampling the down-sampled digital representations using at least one of an interpolation technique or a frequency-domain up-sampling technique, to generate up-sampled time-series representations of respective acoustic echo signals, and processing the up-sampled time-series representations of the respective acoustic echo signals to generate a visual representation of a result of the acoustic inspection operation. Generally, the down-sampled digital representations comprise a lesser volume of data than the up-sampled representations.

In an example, a system for processing compressed acoustic inspection data can include a first processing facility comprising at least one first processor circuit and at least one first memory circuit, along with a first communication circuit communicatively coupled with the first processing facility. The at least one first memory circuit comprises instructions that, when executed by the at least one first processor circuit, cause the system to receive, using the first communication circuit, down-sampled digital representations of acquired acoustic echo data corresponding to respective received acoustic echo signals, the respective received acoustic echo signals corresponding to transducer apertures of a multi-element electroacoustic transducer array used for an acoustic inspection operation, up-sample the down-sampled digital representations using at least one of an interpolation technique or a frequency-domain up-sampling technique, to generate up-sampled time-series representations of respective acoustic echo signals, and process the up-sampled time-series representations of the respective acoustic echo signals to generate a visual representation of a result of the acoustic inspection operation. Generally, as in the example above, the down-sampled digital representations comprise a lesser volume of data than the up-sampled representations.

In an example, the system can include a second processing facility comprising at least one second processor circuit, at least one second memory circuit, along with a second communication circuit communicatively coupled with the second processing facility and communicatively coupled with first communication circuit. The at least one second memory circuit comprises instructions that, when executed by the at least one second processor circuit, cause the system to digitize acoustic echo data acquired by the multi-element electroacoustic transducer array using an analog front-end circuit coupled with the multi-element electroacoustic transducer array, decimate the digitized acoustic echo data to establish the down-sampled digital representations of acquired acoustic echo data, and transmit, using the second communication circuit, the down-sampled digital representations to the first communication circuit.

In an example, a system for processing compressed acoustic inspection data can include a means for digitizing acoustic echo data acquired by a multi-element electroacoustic transducer array, a means for decimating the digitized acoustic echo data to establish down-sampled digital representations of acquired acoustic echo data, a means for receiving the down-sampled digital representations of acquired acoustic echo data corresponding to respective received acoustic echo signals, the respective received acoustic echo signals corresponding to transducer apertures of the multi-element electroacoustic transducer array, a means for up-sampling the down-sampled digital representations using at least one of an interpolation technique or a frequency-domain up-sampling technique, to generate up-sampled time-series representations of respective acoustic echo signals, and a means for processing the up-sampled time-series representations of the respective acoustic echo signals to generate a visual representation of a result of an acoustic inspection operation, where the down-sampled digital representations comprise a lesser volume of data than the up-sampled representations.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2 illustrates generally various examples comprising acoustic acquisition modalities that can be supported by the techniques described herein, along with a related acquisition matrix data format, and related imaging modalities.

FIG. 3A illustrates generally an example comprising an acquisition and processing scheme, such as supporting an acquisition unit that can be used to obtain acoustic echo signals from a multi-element array, and a processing unit that can be used to process received down-sampled digital representations of acquired acoustic echo signals, and to process the down-sampled representations to generate a visual representation of an inspection result.

FIG. 3B illustrates generally another example comprising an acquisition and processing scheme, such as can include, optionally, generation of an analytic signal representation, and, optionally, application of a frequency shift to acquired acoustic echo signals.

FIG. 4A shows an illustrative example of an acquired acoustic echo signal (e.g., representative of an acquired A-scan echo signal), along with a down-sampled (e.g., decimated) representation of the acquired echo signal, and a corresponding up-sampled representation of the acquired echo signal, the up-sampled representation generated using the down-sampled representation.

FIG. 4B shows an illustrative example of a spectrum of an acquired acoustic echo signal (e.g., representative of an acquired A-scan echo signal), along with a corresponding spectrum of an up-sampled representation of the acquired echo signal, for comparison.

FIG. 5A shows an illustrative example of signal-to-noise ratios (SNRs) for flaw regions in imaging data generated using a Total Focusing Method (TFM) imaging technique, the TFM beamforming performed using matrices of acquired A-scan imaging data that has been decimated and up-sampled, where the SNRs are shown for various decimation ratios or “levels.”

FIG. 5B shows an illustrative example of normalized flaw amplitudes for flaw regions in imaging data generated using a Total Focusing Method (TFM) beamforming technique and related imaging, using the same data set as in FIG. 5A, with the TFM beamforming performed using matrices of acquired A-scan imaging data that has been decimated and up-sampled, where the amplitudes are shown for various decimation ratios or “levels.”

FIG. 6A shows an illustrative example of signal-to-noise ratios (SNRs) for flaw regions in imaging data generated using a synthetic Plane Wave Imaging technique, using the same data set as was used for FIG. 5A, but where summation is performed for A-scan time-series data to establish a synthetic plane wave aperture in emission before decimation is performed, with focusing summation then performed using matrices of acquired A-scan imaging data that has been decimated and up-sampled, where the SNRs are shown for various decimation ratios or “levels.”

FIG. 6B shows an illustrative example of normalized flaw amplitudes for flaw regions in imaging data generated using a synthetic Plane Wave Imaging technique, using the same data set as was used for FIG. 5B, but where summation is performed for A-scan time-series data to establish a synthetic plane wave aperture in emission before decimation is performed, with focusing summation then performed using matrices of acquired A-scan imaging data that has been decimated and up-sampled, where the SNRs are shown for various decimation ratios or “levels.”

FIG. 7A, FIG. 7B, FIG. 7C, FIG. 7D, FIG. 7E, and FIG. 7F show illustrative examples of operations for processing an acquired acoustic echo signal that is processed using the scheme shown generally in FIG. 3B.

FIG. 8 illustrates generally a technique that can be used in combination with other techniques shown and described herein, where in the example of FIG. 8, a respective A-scan time-series can be truncated or a duration thereof otherwise established based on a region of interest or propagation mode as established by a time-of-flight.

FIG. 9 illustrates generally a technique, such as a method, that can be used for performing processing of time-series representations, such as to perform one or more of compression or decompression of digital representations of acoustic imaging data.

FIG. 10 illustrates a block diagram of an example comprising a machine upon which any one or more of the techniques (e.g., methodologies) discussed herein may be performed.

### DETAILED DESCRIPTION

Acoustic inspection productivity can be enhanced using techniques to perform compression of acquired acoustic data, such as data corresponding to elementary A-scan or other time-series representations of received acoustic echo data, as mentioned above. In various approaches as described herein, time-series data can be decimated for efficient storage or transmission. The decimation process can be performed in a manner that preserves a frequency spectrum (and related information) of interest without loss within a specified probe signal chain bandwidth but can be used to discard information extending beyond such a specified bandwidth. The present inventors have recognized, among other things, that the representation of the time-series data can be reconstructed from decimated data set, such as by using a frequency domain technique (e.g., a Fourier transform-based up-sampling technique) or a convolutional interpolation filter, as illustrative examples. Use of such a frequency domain technique or convolutional interpolation filter can allow a reconstructed time-series representation to fully represent the information within the specified probe bandwidth from the originally acquired time-series. The techniques described herein can be used for a variety of different acoustic measurement techniques that involve acquisition of time-series data (e.g., A-Scan data). Transmission of compressed acoustic echo data can allow greater inspection productivity such as facilitating processing of such acoustic echo data at a location different from the acquisition or probe location, or even supporting provisioning of processing and related imaging as a service using a remote server or cloud-based approach.

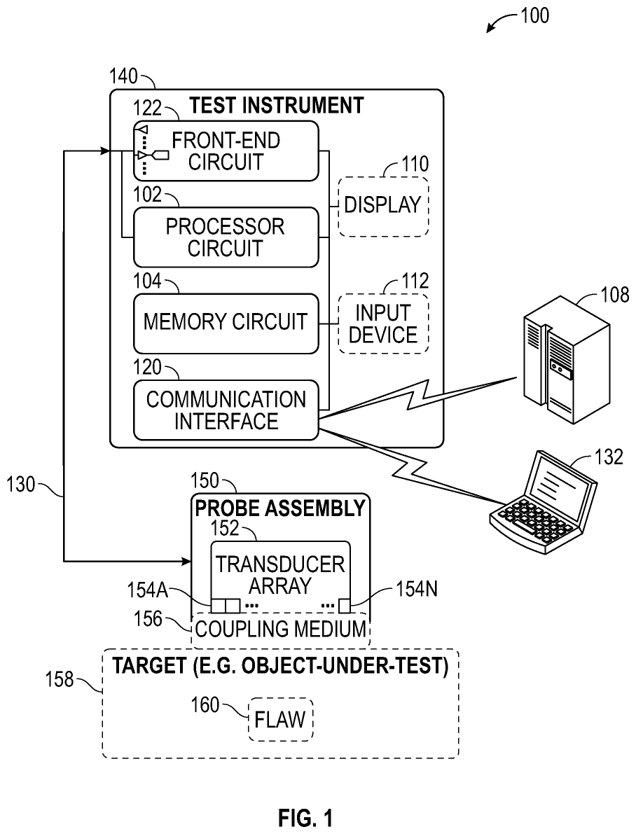

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies 150. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single or multiple probe assemblies 150 for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

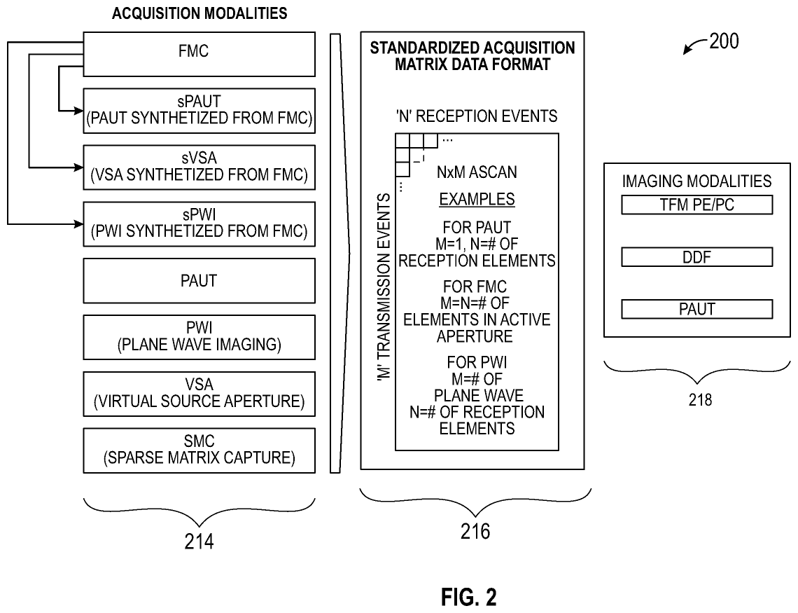

FIG. 2 illustrates generally various examples comprising acoustic acquisition modalities that can be supported by the down-sampling (e.g., decimation) and up-sampling (e.g., frequency-domain up-sampling or time-domain interpolation) techniques described herein, along with a related acquisition matrix data format, and related imaging modalities. At 214, acoustic acquisition can be performed according to a specified imaging modality, such as to acquire acoustic echo data from a multi-element acoustic probe assembly (e.g., a probe assembly having multiple electroacoustic transducers such as forming a linear or matrix array). Such acquisition can include full matrix capture, where respective elementary A-scan time-series representations are digitized and stored in a matrix (such as a specified acquisition matrix having characteristics like the standardized acquisition matrix format mentioned at 216), with elements in the matrix corresponding to acquired time-series data for respective transmit and receive aperture pairs. Such an approach can be referred to as Full Matrix Capture (FMC).

Such acquisition can include some degree of processing before storage or transmission. For example, phased-array ultrasound testing (PAUT), virtual source aperture (VSA) technique, or plane wave imaging (PWI) can be performed by aggregating received echo signals corresponding to a specified group of transmission events. Generally, FMC-based acquisition, PAUT, PWI, VSI, or a sparse matrix capture (SMC) technique can be performed, and the down-sampling and up-sampling techniques described herein are generally applicable for processing of time-series data acquired using any of the various modalities at 214. A specified (e.g., “standardized”) acquisition matrix format can be established as mentioned at 216, such as having dimensionality determined by the acquisition modality as shown in FIG. 2.

Acquired acoustic echo time-series data can be stored as a compressed representation in the acquisition matrix at 216 and transmitted to another processing facility (such as locally or remotely situated with respect to the acquisition probe), and one or more techniques can be performed at 218 to provide a visual representation for a user. Such techniques can include beamforming using PAUT or a Total Focusing Method (TFM) or using another technique. As mentioned elsewhere herein, such time-series data corresponding to acoustic echo signals can be stored, transmitted, compressed, and decompressed using real-valued signal data or using an analytic representation comprising a real-valued representation and an imaginary-valued representation (such as generated using a Hilbert transform or using other techniques as described elsewhere herein).

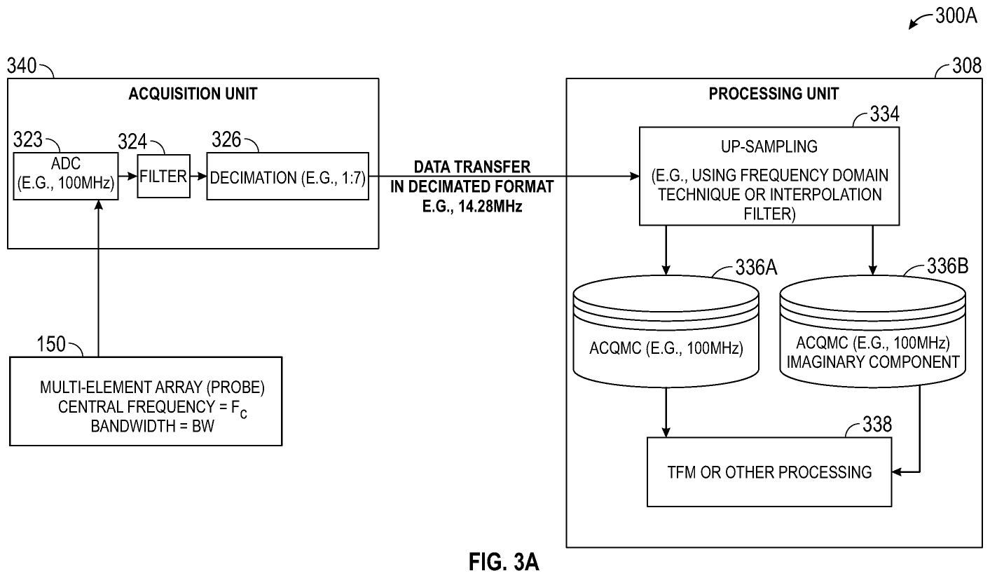

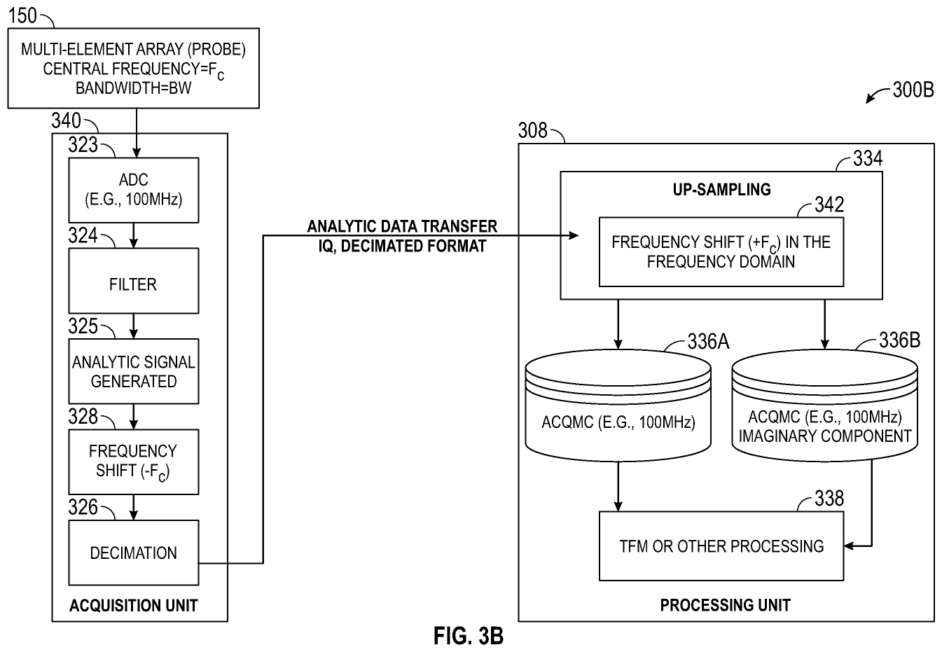

FIG. 3A illustrates generally an example comprising an acquisition and processing scheme 300A, such as supporting an acquisition unit 340 that can be used to acquire acoustic echo signals from a multi-element array 150, and a processing unit 308 that can be used to process received down-sampled digital representations of acquired acoustic echo signals, and to process the down-sampled representations to generate a visual representation of an inspection result using TFM beamforming or another technique at 338. The acquisition unit 340 generally includes one or more processor circuits and a corresponding memory, and such processor circuitry can include application specific or field-programmable processor circuitry configured to perform specified operations power-efficiently. The processing unit 308 can be separate from the acquisition unit 340, such as including a desktop or laptop computer, or a centralized server or clouding computing facility, such as having one more processor circuits and associated memory that have different capabilities than the acquisition unit 340. For example, the processing unit 308 may have a network interface to receive a compressed representation of acquired acoustic echo data provided by the acquisition unit 340, and the processing unit 308 may support an application programming interface (API) or other specified interface to allow processing (such as computation supporting imaging operations) that can be offloaded from the acquisition unit 340.

Generally, as mentioned above, the multi-element array 150 can include or can be electrically coupled with an analog front end, such as including an analog-to-digital converter ADC 323. The probe (or another probe in a pitch/catch scheme) can generate an acoustic pulse from a specified transmit aperture (e.g., a single transducer or a specified group of transducers), having a central acoustic frequency, “Fc,” and bandwidth, “BW.” Resulting acoustic echo signals from each transmit event can be digitized using the ADC 323 (or an array of such ADC 32 channels, such as corresponding to each element in the multi-element array). Respective acoustic echo signals (such as A-scan time-series representations) can be filtered digitally using a discrete-time filter 324, such as a low-pass or bandpass filter, and at 326, the respective acoustic echo signals can be decimated. The filter 324 can be used to suppress higher frequency components such as having a cut-off frequency corresponding to a Nyquist rate of the down-sampled sample rate, avoiding aliasing artifacts.

Decimation generally refers to dropping samples from a time-series according to a specified decimation level or ratio. For example, a 1:7 decimation ratio or decimation level of “7” implies that only one out of every seven samples will be retained from the acquired time series, and the remaining samples are dropped. Accordingly, “decimation” does not literally require a 1:10 ratio, and merely refers down-sampling the time-series to achieve a longer sample interval, and a correspondingly lesser time-series record size in terms of data storage, assuming that the amplitude resolution remains the same. The down-sampled digital representations of the acquired acoustic echo data can be transmitted to the processing unit 308, such as for up-sampling at 334. In one approach, the down-sampled digital representations can be zero-padded in the time domain such as by inserting zero-valued samples between non-zero amplitude samples in the decimated time-series, where the zero-valued samples have a desired shorter sample interval corresponding to an up-sampling target sample rate. Zero-padding in the time-domain, without more, may result in missing peak information or other features corresponding to discarded signal components beyond the cutoff frequency of the filter 324 (e.g., aliasing artifacts).

In the illustration of FIG. 3A, the original acquired acoustic echo data can be sampled at 100 megahertz (MHz) (e.g., 100 mega-samples per second), then decimated 1:7 at 326 to achieve a down-sampling to a 14.28 MHz sample rate, then up-sampled at 334 back to 100 MHz for further processing. Transmission or storage of the compressed (e.g., decimated) record sampled at 14.28 MHz can be far more efficient than storing all data acquired at the full 100 MHz sample rate. The numerical values mentioned above are merely illustrative examples. At 336A and 336B, after up-sampling, acquisition matrices conforming to a specified format (such as the standard acquisition format shown at 216 in FIG. 2) are provided, such as including a real-valued set of time-series representations at 336A, and imaginary-valued counterparts at 336B, to provide an analytic representation of the time-series representations with the combination of records at 336A and 336B. The analytic representation of records at 336A and 336B can be generated contemporaneously with the up-sampling at 334, as discussed below.

The present inventors have recognized that various approaches can be used to improve the quality of an up-sampled time-series representation. As discussed further below, the up-sampling at 334 can include use of a convolutional interpolation filter, such as a polynomial interpolation filter, or a frequency-domain based technique. As an illustration, the present inventors have recognized, among other things, that use of a polynomial interpolation filter or frequency-domain based technique can help suppress or eliminate a loss of amplitude stability that may otherwise occur due to loss of peak information in the decimation at 326.

The frequency-domain upsampling technique can include performing a discrete Fourier transform (DFT) or computational equivalent (e.g., Fast Fourier Transform (FFT)) on a respective down-sampled time-series representation. In the frequency domain, additional zero-valued frequency bins can be added extending beyond the Nyquist frequency of the transformed time-series data (where this Nyquist frequency corresponds to the decimated-lower-sample rate). After such zero-padding in the frequency domain, an inverse transform (e.g., iDFT or iFFT) can be performed, to provide a corresponding up-sampled time-series.

The up-sampling at 334 can also include use of a Hilbert transform operator in the frequency domain, such as applied before zero padding in the frequency domain. In this manner, the up-sampling workflow can include transforming the down-sampled (e.g., decimated) time-series data into the frequency domain, then applying a Hilbert transform or other multiplicative operator to generate a real-valued spectrum and an imaginary-valued spectrum (or a complex-valued spectrum including real and imaginary-valued signal components corresponding to each frequency bin). The application of the Hilbert transform before zero padding can provide enhanced computational efficiency in at least two respects. First, the size (and corresponding data footprint) of the frequency domain representation of the transformed time-series data can be smaller before zero padding, and the application of a Hilbert transform (e.g., multiplicatively) is performed on fewer data values as compared to a record that is zero padded in the frequency domain. Zero padding in the frequency domain can be performed after the Hilbert transform operation is performed. Second, the real and imaginary components provided at 336A and 336B can be established contemporaneously when the zero-padded frequency domain representation is inverted to provide the up-sampled time-series representation. In this manner, an extra operation of generating the real and imaginary components at 336A and 336B is avoided.

In addition, or alternatively, a time-domain technique can be used for such up-sampling and recovery of peak information at 334. For example, the down-sampled time-series representations can be zero-padded in the time domain as mentioned above, and a convolutional (e.g., digital) filter can be applied to the down-sampled time-series representations wherein the filter time steps correspond to the sample interval of the up-sampled data (e.g., at the up-sampled—higher—sample rate). The convolutional filter can include an impulse response defined by a piece-wise set of polynomial expressions. An example of a symmetric polynomial interpolation filter (where h(t) is the time-domain impulse response of the filter) can be implemented as follows:

$$\\ \begin{matrix}h ( t ) = \{ \begin{matrix}\text{?} & + & \text{?} & + & \text{?} & & - \frac{5}{2} < t \leq - \frac{3}{2} \\ {{a}_{1} ( \text{?} - 1 )}^{2} & + & {b}_{1} ( \text{?} - 1 ) & + & {c}_{1} & & - \frac{3}{2} < t \leq - \frac{1}{2} \\ \text{?} & & & + & \text{?} & for & - \frac{1}{2} < t \leq \frac{1}{2} \\ {a}_{1} {( \text{?} 1 )}^{2} & + & {b}_{1} ( \text{?} 1 ) & + & {c}_{1} & & \frac{1}{2} < t \leq \frac{3}{2} \\ \text{?} & + & \text{?} & + & \text{?} & & \frac{3}{2} < t \leq \frac{5}{2} \\ & & & & 0 & otherwise & \end{matrix} & EQN . 1\end{matrix}$$

$$\\ \text{?} \text{indicates text missing or illegible when filed}$$

FIG. 3B illustrates generally another example comprising an acquisition and processing scheme 300B, similar to the scheme 300A of FIG. 3A, but also including, optionally, generation of an analytic signal representation at 325, and, optionally, application of a frequency shift to acquired acoustic echo signals at 328, and removal of the frequency shift at 342. As in FIG. 3A, an acquisition unit (e.g., a field instrument) can include an ADC 323 that can be used to digitize respective acoustic echo signals, and such signals can be filtered using a digital filter 324. Use of a band-pass filter frequency response can suppress both unneeded higher-frequency components, and DC or near-DC components. At 325, an analytic representation of the acquired time-series signals can be generated, such as using a Hilbert filter to establish an imaginary-valued time-series to accompany a corresponding real-valued acquired time-series for each acquired A-scan or other acquired time-series of acoustic echo signal data. At 328, a frequency shift (e.g., down-conversion) can be performed, such as to shift sidebands around the acoustic pulse center frequency, Fc, to DC or near-DC (e.g., zero frequency, using a “−Fc” shift). At 326, decimation can be performed as in FIG. 3A, but such decimation can be applied to both the in-phase and quadrature (e.g., imaginary-valued) components of the analytic signal representations, and decimated IQ analytic signal representations can be transferred (such as transmitted via a wired or wireless network) to a processing unit 308.

In the processing unit, up-sampling can be performed as in FIG. 3A, but optionally, if a frequency shift was performed at 328, a corresponding frequency shift can be performed at 342 to upconvert (e.g., shift) the acoustic echo signal information from DC or near DC back to the acoustic pulse center frequency, Fc (e.g., a “+Fc” shift), such as in combination with frequency-domain up-sampling as mentioned above. As in FIG. 3A, at 336A and 336B, after up-sampling, acquisition matrices conforming to a specified format can be provided, and a visual representation of an inspection result can be generated, such as using TFM beamforming or other processing at 338. The present inventors have recognized, among other things, that the processing approach shown in FIG. 3A and FIG. 3B does not require a discrete Fourier transform or FFT to be implemented in the acquisition unit (e.g., field instrument).

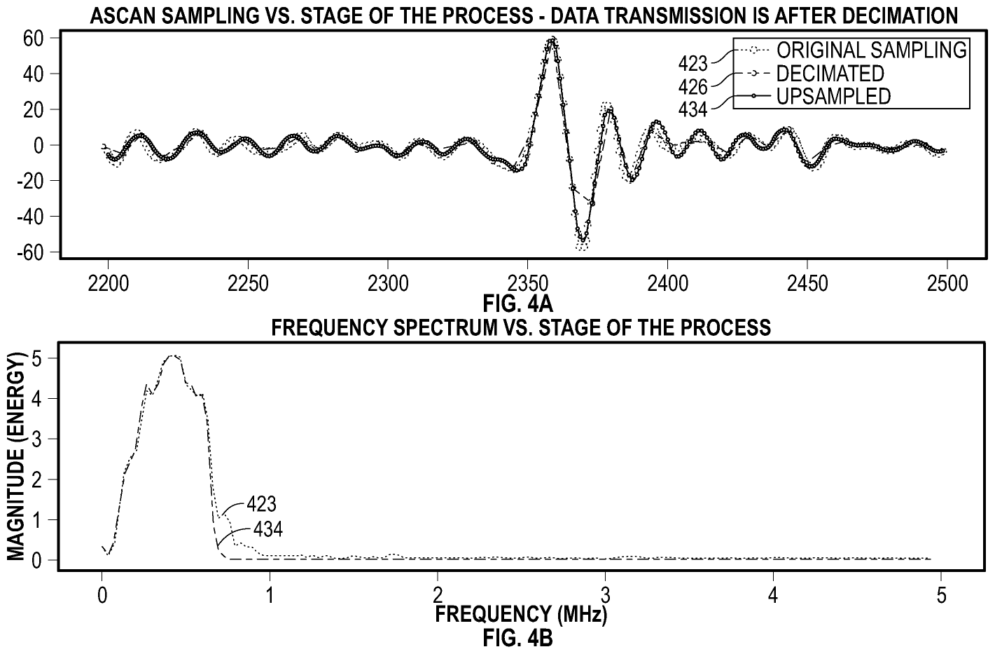

FIG. 4A shows an illustrative example of an acquired acoustic echo signal 423 (e.g., representative of an acquired A-scan echo signal), along with a down-sampled (e.g., decimated) representation 426 of the acquired echo signal, and a corresponding up-sampled representation 434 of the acquired echo signal, the up-sampled representation 434 generated using the down-sampled representation and a frequency-domain approach as discussed elsewhere herein. The decimated representation 426 was not filtered prior to decimation, and in this example, the Fc value is about 5 MHz.

FIG. 4B shows an illustrative example of a spectrum of the acquired acoustic echo signal 423 (e.g., representative of an acquired A-scan echo signal) of FIG. 4A, along with a corresponding spectrum of an up-sampled representation 434 of the acquired echo signal, for comparison. Despite decimation (e.g., down-sampling) and up-sampling, the resulting spectrum of the up-sampled representation 434 is quite similar below about 7.14 MHz, as expected, because 7.14 MHz corresponds to the Nyquist rate for a 100 MHz signal that is decimated with a 1:7 ratio (e.g., 100 MHz divided by seven, then divided by two).

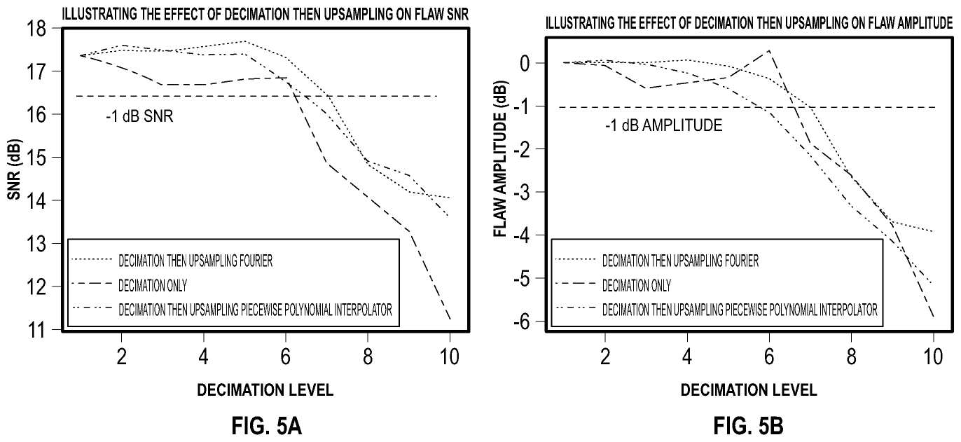

FIG. 5A shows an illustrative example of signal-to-noise ratios (SNRs) for flaw regions in imaging data generated using a Total Focusing Method (TFM) beamforming technique, the TFM beamforming performed using matrices of acquired A-scan imaging data that has been decimated and up-sampled, where the SNRs are shown for various decimation ratios or “levels,” and FIG. 5B shows an illustrative example of normalized flaw amplitudes for flaw regions in imaging data generated using a Total Focusing Method (TFM) beamforming technique, using the same data set as in FIG. 5A, with the TFM beamforming performed using matrices of acquired A-scan imaging data that has been decimated and up-sampled, where the amplitudes are shown for various decimation ratios or “levels.” According to experimentally-obtained results referenced to TFM using undecimated 100 MHz full matrix capture (FMC) A-scan data acquired using a TT-T mode, the plots in FIG. 5A and FIG. 5B generally illustrate that decimation levels of 1:7 or less (e.g., 1:6, 1:5, 1:4, etc.) do not result in degradation (e.g., reduction) of flaw SNR and flaw amplitude as compared to decimation levels of 1:8 or higher. The present inventors also observed that qualitatively, an intensity of flaws begin to fluctuate, and artifacts begin to appear at decimation levels of 1:8 or more, in this illustrative example. By way of comparison, FIG. 5A and FIG. 5B also flaw SNR and flaw amplitude for both the frequency-domain based up-sampling approach (labeled “Fourier”) and for a time-domain polynomial interpolator. A plot is also included of an up-sampling approach where only time-domain zero-padding is used without using the frequency-domain technique or a time-domain polynomial interpolator. This is labeled as “decimation only” in FIG. 5A and FIG. 5B.

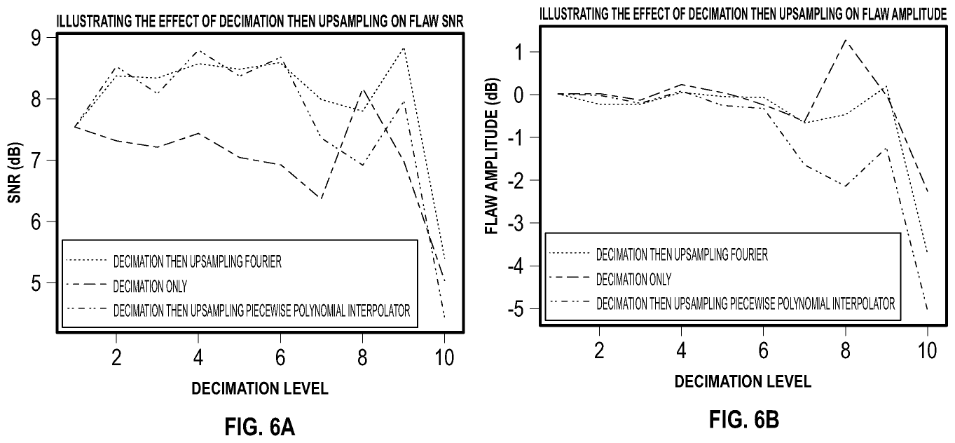

FIG. 6A shows an illustrative example of signal-to-noise ratios (SNRs) for flaw regions in imaging data generated using a synthetic Plane Wave Imaging technique, using the same data set as was used for FIG. 5A, but where summation is performed for A-scan time-series data to establish a synthetic plane wave aperture in emission before decimation is performed, with focusing summation then performed using matrices of acquired A-scan imaging data that has been decimated and up-sampled, where the SNRs are shown for various decimation ratios or “levels,” and FIG. 6B shows an illustrative example of normalized flaw amplitudes for flaw regions in imaging data generated using a synthetic Plane Wave Imaging technique, using the same data set as was used for FIG. 5B, but where summation is performed for A-scan time-series data to establish a synthetic plane wave aperture in emission before decimation is performed, with focusing summation then performed using matrices of acquired A-scan imaging data that has been decimated and up-sampled, where the SNRs are shown for various decimation ratios or “levels.” Similar to FIG. 5A and FIG. 5B, decimation levels of 1:8 or more result in degradation or instability of detected flaw amplitude and flaw SNR.

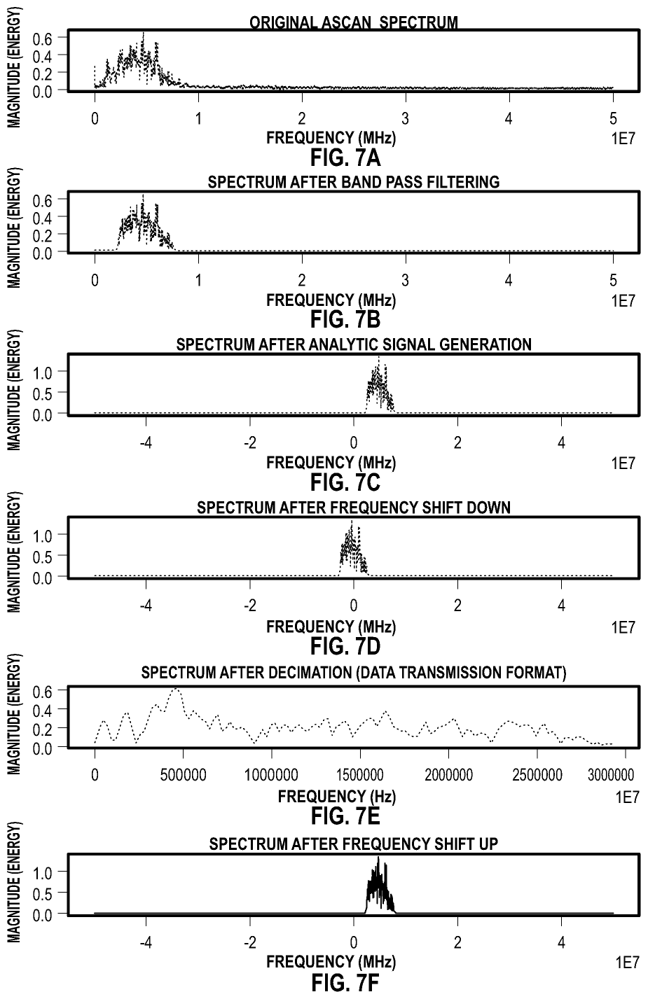

FIG. 7A, FIG. 7B, FIG. 7C, FIG. 7D, FIG. 7E, and FIG. 7F show illustrative examples of operations for processing an acquired acoustic echo signal that is processed using the scheme shown generally in FIG. 3B. Referring to FIG. 7A, a representative A-scan echo signal spectrum is shown (magnitude versus frequency, with frequency in MHz.). Bandpass filtering can be performed such as in the digital domain as mentioned above. A pass-band frequency range can be established such as based on a transducer element bandwidth or probe signal chain bandwidth. Referring to FIG. 7B, the spectrum of FIG. 7B shows a result of such band-pass filtering. Referring to FIG. 7C, an analytic representation can be generated, suppressing energy at negative frequency values, with the energy still centered around +Fc, the center frequency of acoustic transmission. A frequency shift can be performed to provide the zero-frequency-centered representation at FIG. 7D, allowing higher frequency residues to be disregarded. Decimation can be performed to provide the spectrum of FIG. 7E (showing magnitude versus frequency, in Hz.).

The decimated time-series data corresponding to the spectrum shown in FIG. 7E can be transferred to a processing facility. A degree or “level” of decimation can be defined in part using information about an acquisition ADC sample rate, and a bandpass filter width, ΔBP, both in Hz., such that a decimation level does not exceed Fs/ΔBP (for example seven, corresponding to a 1:7 decimation ratio). A time-series corresponding to the decimated frequency spectrum of FIG. 7E (e.g., a compressed representation) can be transferred using a specified data format, such as represented as 16-bit integers transferred in interleaved form, where in-phase (“I,” real valued) and quadrature (“Q,” imaginary-valued) components of the analytic signal representation are transmitted as integer values corresponding to a count of discrete amplitude quantizing levels. For example, the interleaved transmitted time-series can have the form: I(sample #1):Q(sample #1):I(sample #2):Q(sample #2): etc. The flexibility of the approach herein allows use of down-sampling to maintain existing performance in terms of amplitude, time resolution, and SNR within a specified probe bandwidth, or allows for different (e.g., lower) native digitization rates, differing input amplitude range, or SNR specification to accommodate evolving performance requirements.

Referring to FIG. 7F, a received decimated time-series can be frequency shifted in a manner to re-establish the received acoustic echo signal energy at or near the transmit pulse center frequency, Fc, and the spectrum of FIG. 7F shows that the frequency-shifted representation is similar to FIG. 7C prior to decimation and transmission. The present inventors have experimentally evaluated relatively significant data size reductions using factors of 6.5×, 8.5×, or even 12.5× data reduction by specifying a band-pass filter bandwidth corresponding to a probe bandwidth and sample rate, as mentioned above, and allowing some degree of transition between pass-band and stop-band in the band-pass filter (e.g., for a 3-7 MHz probe bandwidth, transitions from pass-band to stop-band can be about 500 KHz each on either side of a pass-band region). Further data reduction is possible, such as by truncating or adjusting the temporal start time, stop time, or duration of an acquired acoustic echo signal time-series based on establishing a region-of-interest or otherwise using time-of-flight (ToF) information.

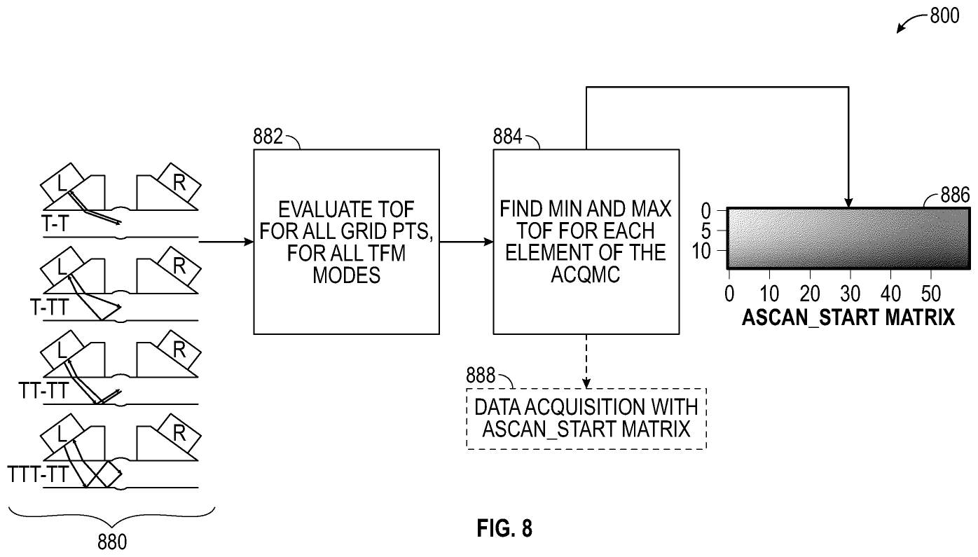

For example, FIG. 8 illustrates generally a technique 800 that can be used in combination with other techniques shown and described herein, such as to provide techniques for further reduction of echo data set size. In the example of FIG. 8, a respective A-scan time-series can be truncated or a duration thereof otherwise established based on a region of interest and corresponding propagation mode as established by a time-of-flight determination. For example, one more propagation modes can be identified at 880, and at 882, corresponding times of flight (TOFs) can be established at all grid points (e.g., imaging grid points) of interest, using nominal propagation characteristics and by ray-casting a transmitted beam a received beam for each grid location for each mode. At 884, for example, a minimum time-of-flight, a maximum time-of-flight, or both, can be identified for each time-series in an acquisition matrix. At 886, a matrix of values, such as starting time index values, can be established, such as to be sure that the echo data adequately captures reflections corresponding to the grid location based on a determined ToF.

In the illustration of FIG. 8 of the start time index matrix at 886, a synthetic PWI (or PWI) acquisition matrix is generated at 888, such as having a vertical axis (defining rows) corresponding to respective transmit plane wave apertures and 64 receive element apertures across the horizontal axis. The start time index matrix shows intensity values corresponding to time-series start indices, illustrating that the start values vary depending on the transmit aperture, and the receive element. The start matrix (or other indicia of A-scan record length based on TOFs) can be used control acquisition at 888, or to provide temporal indices to control truncation or otherwise facilitate adjustment of a duration of acquired A-scan or other echo signals. In this manner, acquired echo signal data from time indices outside the desired region of interest based on TOF can be discarded or ignored, and need not be stored or transmitted (or even acquired). The example of FIG. 8 refers to PWI, but the technique shown is applicable to other imaging modalities, such as for control of FMC acquisition for TFM beamforming, for example.

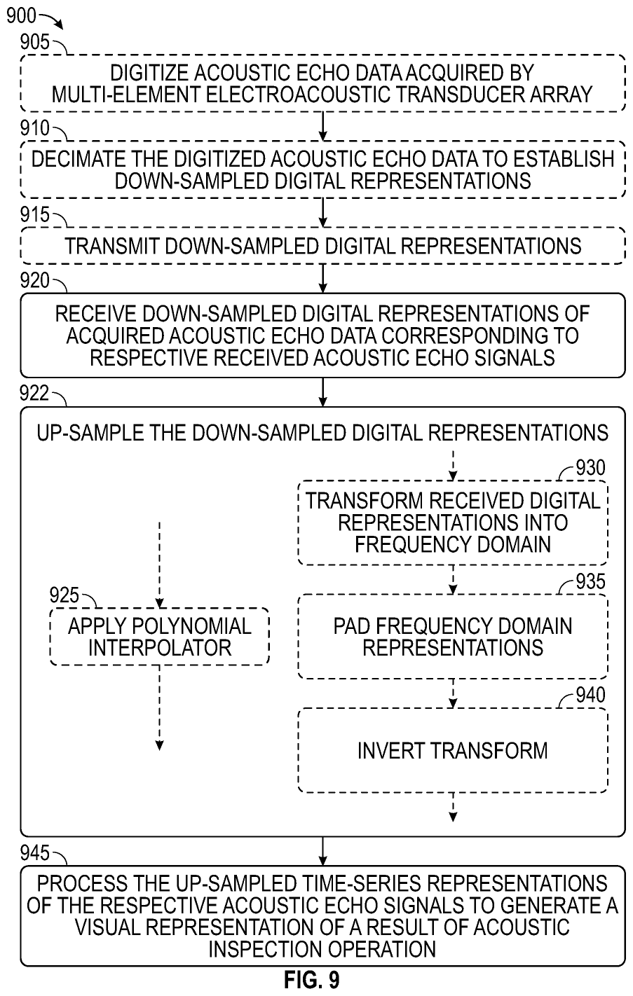

FIG. 9 illustrates generally a technique 900, such as a method, that can be used for performing processing of time-series representations, such as to perform one or more of compression or decompression of digital representations of acoustic imaging data. At 920, down-sampled (e.g., decimated) digital representations of acquired acoustic echo data can be received, such as received at an acquisition unit over a communication interface (e.g., a communication circuit) such as a network interface. The representations can include time-series representations of respective acoustic echo signals received in response to respective acoustic transmission events. At 922, the down-sampled digital representations can be up-sampled. For example, in a frequency-domain approach, the digital representations can be transformed into the frequency domain at 930 and corresponding frequency domain representations can be padded at 935 as discussed above. At 940, the transform can be inverted to provide corresponding time-series representations having sample intervals that are shorter in duration (e.g., corresponding to a higher sample rate) than the down-sampled representation received at 920. Optionally, before inversion at 940 or padding at 935, an analytic signal representation can be generated comprising real-valued and imaginary-valued signal components, as discussed above. Incorporation of a Hilbert transform operation in the frequency domain, or other technique to generate the analytic signal representation, before padding in the frequency domain at 935, can provide enhanced computational efficiency versus other approaches.

Alternatively, or in addition, a convolutional filter (e.g., a discrete-time piece-wise polynomial interpolation filter or other filter) can be applied to the down-sampled digital representations received at 920, in the time-domain, such as applied to a zero-padded representation of the down-sampled data as discussed above. At 945, the up-sampled time-series representations can be processed (e.g., coherently summed), such as to generate a visual representation of a result of an acoustic inspection operation. Such a visual representation can include a magnitude or intensity plot associated with TFM beamforming, as illustrative examples. Other imaging modalities can be used, as discussed above.

The technique 900 can include digitizing acoustic echo data acquired by a multi-element electroacoustic transducer array at 905, decimating the digitized acoustic echo data to establish the down-sampled representations at 910, and transmission of the down-sampled digital representations at 915, such as using a communication interface (e.g., a communication circuit) such as a network interface.

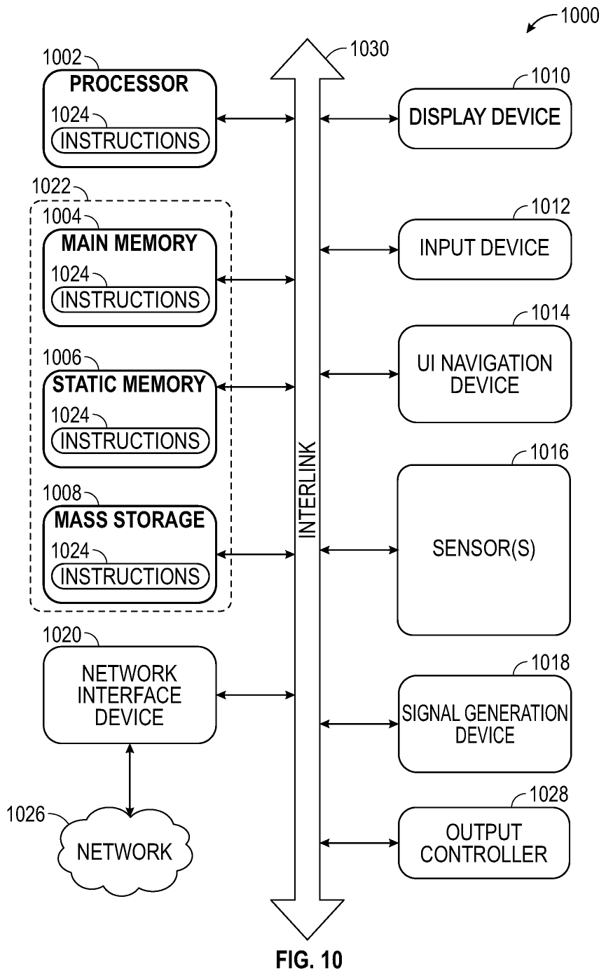

FIG. 10 illustrates a block diagram of an example comprising a machine 1000 upon which any one or more of the techniques (e.g., methodologies) discussed herein may be performed. Machine 1000 (e.g., computer system) may include a hardware processor 1002 (e.g., a central processing unit (CPU), a graphics processing unit (GPU), a hardware processor core, or any combination thereof), a main memory 1004 and a static memory 1006, connected via an interconnect 1008 (e.g., link or bus), as some or all of these components may constitute hardware for systems or related implementations discussed above.

Specific examples of main memory 604 include Random Access Memory (RAM), and semiconductor memory devices, which may include storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: RAM: or optical media such as CD-ROM and DVD-ROM disks.

The machine 1000 may further include a display device 1010, an input device 1012 (e.g., a keyboard), and a user interface (UI) navigation device 1014 (e.g., a mouse). In an example, the display device 1010, input device 1012 and UI navigation device 1014 may be a touch-screen display. The machine 1000 may include a mass storage device 1016 (e.g., drive unit), a signal generation device 1018 (e.g., a speaker), a network interface device 1020, and one or more sensors 1030, such as a global positioning system (GPS) sensor, compass, accelerometer, or some other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the mass storage device 1016 comprises a machine readable medium.

Specific examples of machine readable media include, one or more of non-volatile memory, such as semiconductor memory devices (e.g., EPROM or EEPROM) and flash memory devices: magnetic disks, such as internal hard disks and removable disks: magneto-optical disks: RAM: or optical media such as CD-ROM and DVD-ROM disks. While the machine readable medium 1022 is illustrated as a single medium, the term “machine readable medium” may include a single medium or multiple media (e.g., a centralized or distributed database, or associated caches and servers) configured to store the one or more instructions 1024.

Δn apparatus of the machine 1000 includes one or more of a hardware processor 1002 (e.g., a central processing unit (CPU), a graphics processing unit (GPU), a hardware processor core, or any combination thereof), a main memory 1004 and a static memory 1006, sensors 1030, network interface device 1020, antennas 1032, a display device 1010, an input device 1012, a UI navigation device 1014, a mass storage device 1016, instructions 1024, a signal generation device 1018, or an output controller 1028. The apparatus may be configured to perform one or more of the methods or operations disclosed herein.

The term “machine readable medium” includes, for example, any medium that is capable of storing, encoding, or carrying instructions for execution by the machine 1000 and that cause the machine 1000 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine readable media include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: Random Access Memory (RAM): or optical media such as CD-ROM and DVD-ROM disks. In some examples, machine readable media includes non-transitory machine-readable media. In some examples, machine readable media includes machine readable media that is not a transitory propagating signal.

The instructions 1024 may be transmitted or received, for example, over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 1020 includes one or more physical jacks (e.g., Ethernet, coaxial, or other interconnection) or one or more antennas to access the communications network 1026. In an example, the network interface device 1020 includes one or more antennas 1032 to wirelessly communicate using at least one of single-input multiple-output (SIMO), multiple-input multiple-output (MIMO), or multiple-input single-output (MISO) techniques. In some examples, the network interface device 1020 wirelessly communicates using Multiple User MIMO techniques. The term “transmission medium” shall be taken to include any intangible medium that is capable of storing, encoding or carrying instructions for execution by the machine 1000, and includes digital or analog communications signals or other intangible medium to facilitate communication of such software.

### Various Notes

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for processing compressed acoustic inspection data, the machine-implemented method comprising:
receiving down-sampled digital representations of acquired acoustic echo data corresponding to respective received acoustic echo signals, the respective received acoustic echo signals corresponding to transducer apertures of a multi-element electroacoustic transducer array used for an acoustic inspection operation;
up-sampling the down-sampled digital representations using at least one of an interpolation technique or a frequency-domain up-sampling technique, to generate up-sampled time-series representations of respective acoustic echo signals; and
processing the up-sampled time-series representations of the respective acoustic echo signals to generate a visual representation of a result of the acoustic inspection operation;
wherein the down-sampled digital representations comprise a lesser volume of data than the up-sampled representations.

2. The machine-implemented method of claim 1, wherein the up-sampling the down-sampled digital representations comprises the frequency-domain up-sampling technique, the frequency-domain up-sampling technique comprising:
transforming the received down-sampled digital representations into the frequency domain to provide respective frequency-domain representations;
padding the respective frequency-domain representations to create padded frequency-domain representations including additional frequency bins; and
inverting the padded frequency-domain representations to provide the up-sampled time-series representations of the respective acoustic echo signals.

3. The machine-implemented method of claim 2, wherein the transforming comprises a discrete Fourier transform operation; and
wherein the inverting comprises an inverse discrete Fourier transform operation.

4. The machine-implemented method of claim 1, wherein the up-sampling the down-sampled digital representations includes applying a polynomial interpolator.

5. The machine-implemented method of claim 1, comprising generating analytic representations of the up-sampled time-series representations of the acoustic echo signals for the processing to generate the visual representation, the generating the analytic representations comprising establishing a real-valued component and an imaginary-valued component related to the real-valued component by a Hilbert transform operation.

6. The machine-implemented method of claim 5, wherein the generating the analytic representations comprises applying a Hilbert transform operation in the frequency domain as a portion of the frequency-domain up-sampling technique, prior to padding the respective frequency-domain representations.

7. The machine-implemented method of claim 1, further comprising:
digitizing acoustic echo data acquired by the multi-element electroacoustic transducer array; and
decimating the digitized acoustic echo data to establish the down-sampled digital representations of acquired acoustic echo data.

8. The machine-implemented method of claim 7, further comprising filtering the acquired acoustic echo data using a filter to reject frequencies at least above a specified cutoff frequency.

9. The machine-implemented method of claim 8, wherein the filter comprises a band-pass filter.

10. The machine-implemented method of claim 1, comprising generating analytic representations of the digitized acoustic echo data, the generating the analytic representations comprising establishing a real-valued component and an imaginary-valued component related to the real-valued component by a Hilbert transform operation.

11. The machine-implemented method of claim 1, wherein down-sampled digital representations of acquired acoustic echo data are down-converted using a specified frequency offset.

12. The machine-implemented method of claim 11, wherein the specified frequency offset corresponds to an acoustic center frequency used for transmission of an acoustic pulse eliciting a respective acoustic echo signal.

13. The machine-implemented method of claim 11, wherein the up-sampling the down-sampled digital representations comprises the frequency-domain technique, the frequency-domain technique comprising up-converting the down-sampled digital representations of acquired acoustic echo data using the specified frequency offset.

14. The machine-implemented method of claim 1, wherein the up-sampled time-series representations comprise A-scan representations.

15. The machine-implemented method of claim 14, wherein the A-scan representations have respective durations defined by a time-of-light corresponding to a region of interest on or within a structure.

16. The machine-implemented method of claim 15, wherein the region of interest is established based on a selected acoustic propagation mode.

17. The machine-implemented method of claim 16, wherein the mode comprises a transverse acoustic mode; and
wherein processing the up-sampled time-series representations of the respective acoustic echo signals to generate the visual representation of the result of the acoustic inspection operation comprises performing a Total Focusing Method (TFM) using a matrix of the A-scan representations, where elements in the matrix correspond to specified transmit and receive aperture pairs.

18. A system for processing compressed acoustic inspection data, the system comprising:
a first processing facility comprising:
at least one first processor circuit; and
at least one first memory circuit;
a first communication circuit communicatively coupled with the first processing facility;
wherein the at least one first memory circuit comprises instructions that, when executed by the at least one first processor circuit, cause the system to:
receive, using the first communication circuit, down-sampled digital representations of acquired acoustic echo data corresponding to respective received acoustic echo signals, the respective received acoustic echo signals corresponding to transducer apertures of a multi-element electroacoustic transducer array used for an acoustic inspection operation;
up-sample the down-sampled digital representations using at least one of an interpolation technique or a frequency-domain up-sampling technique, to generate up-sampled time-series representations of respective acoustic echo signals; and
process the up-sampled time-series representations of the respective acoustic echo signals to generate a visual representation of a result of the acoustic inspection operation;
wherein the down-sampled digital representations comprise a lesser volume of data than the up-sampled representations.

19. The system of claim 18, further comprising:
a second processing facility comprising:
at least one second processor circuit; and
at least one second memory circuit; and
a second communication circuit communicatively coupled with the second processing facility and communicatively coupled with first communication circuit;
wherein the at least one second memory circuit comprises instructions that, when executed by the at least one second processor circuit, cause the system to:
digitize acoustic echo data acquired by the multi-element electroacoustic transducer array using an analog front-end circuit coupled with the multi-element electroacoustic transducer array;
decimate the digitized acoustic echo data to establish the down-sampled digital representations of acquired acoustic echo data; and
transmit, using the second communication circuit, the down-sampled digital representations to the first communication circuit.

20. The system of claim 19, wherein the first communication circuit and the second communication circuit comprise network interface circuits.

21. The system of claim 19, further comprising:
the multi-element electroacoustic transducer array; and
the analog front-end circuit;
wherein the second processing facility, the second communication circuit, the multi-element electroacoustic transducer array, and the front-end circuit are co-located in a different location than the first processing facility and the first communication circuit.

22. The system of claim 18, further comprising a user interface configured to:
receive an input triggering acquisition of the acoustic echo data; and
present the visual representation of a result of the acoustic inspection operation.

23. The system of claim 18, wherein
the up-sampled time-series representations comprise A-scan representations, and wherein the instructions to process the up-sampled time-series representations of the respective acoustic echo signals to generate the visual representation of the result of the acoustic inspection operation comprises performing a Total Focusing Method (TFM) using a matrix of the A-scan representations, where elements in the matrix correspond to specified transmit and receive aperture pairs.

24. The system of claim 23, wherein the A-scan representations have respective durations defined by a time-of-light corresponding to a region of interest on or within a structure, the time-of-flight established using nominal parameters corresponding to at least one specified propagation mode.

25. A system for processing compressed acoustic inspection data, the system comprising:
a means for digitizing acoustic echo data acquired by a multi-element electroacoustic transducer array;
a means for decimating the digitized acoustic echo data to establish down-sampled digital representations of acquired acoustic echo data;
a means for receiving the down-sampled digital representations of acquired acoustic echo data corresponding to respective received acoustic echo signals, the respective received acoustic echo signals corresponding to transducer apertures of the multi-element electroacoustic transducer array;
a means for up-sampling the down-sampled digital representations using at least one of an interpolation technique or a frequency-domain up-sampling technique, to generate up-sampled time-series representations of respective acoustic echo signals; and
a means for processing the up-sampled time-series representations of the respective acoustic echo signals to generate a visual representation of a result of an acoustic inspection operation;
wherein the down-sampled digital representations comprise a lesser volume of data than the up-sampled representations.
